(19) United States
(12) Patent Application Publication
(10) Pub. No.: US 2009/0298888 A1
(43) Pub. Date: Dec. 3, 2009

(54) Method of improving plant development and increasing the resistance of plants to soil-borne harmful fungi

(76) Inventors: Wolfgang Thielert, Odenthal (DE); Peter Marczok, Koln (DE); Kai-Uwe Brueggen, Mumbai (IN); Wolfram Andersch, Bergisch Gladbach (DE); Konstantinos Bloukidis, Athens (GR); Alexandros Georgiou, Athens (GR)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/920,637

(22) PCT Filed: May 6, 2006
(86) PCT No.: PCT/EP2006/004257

§ 371 Date: Jun. 22, 2009

(51) Int. Cl. A01N 43/40; A01P 3/00

(52) U.S. Cl. 514/341

(57) ABSTRACT

The present invention relates to a method of improving plant growth and increasing the resistance of plants to soil-borne harmful fungi by directly admixing neonicotinoid-containing formulations into nutrient solutions conventionally employed in raising plants.

The present invention relates to a method of improving plant development and increasing the resistance of plants to soil-borne harmful fungi by directly admixing neonicotinoid-containing formulations into nutrient solutions employed in “floating” methods.

Raising healthy and uniformly grown young plants is an essential prerequisite for the large-scale production and economical management of agricultural, horticultural and silvicultural crops.

A large number of methods for raising young plants are established in agriculture, silviculture and horticulture. Media which are employed for this are, in addition to steam-treated soil, specific media, some of which are based on bog mosses, coconut fibres, rockwool, such as, for example, Grodan®, pumice, expanded clay such as, for example, Lecaton® or Lecadan®, clay granules such as, for example, Seramis®, foams, such as, for example Baystrat®, vermiculites, perlites, synthetic soils such as, for example, Hygromull®, or combinations of these media, into which seed, either untreated or treated with fungicides and/or insecticides, is sown.

In the case of specific crops such as, for example, tobacco, young plants are increasingly known in what is known as the “float” or “floating method” (Leal, 2001; Rudolph and Rogers, 2001; Ntzanis, 2003). In this method, the seed is sown into specific seedling compost based on peat media, in specific containers, for example perforated trays made of polystyrene, and subsequently grown in containers comprising a suitable nutrient solution until the plants have reached the desired size for transplantation (FIG. 1). Here, the containers are allowed to float on the nutrient solution, which is where the method takes its name from (Leal, 2001).

To protect the emerging seed or transplantation material from fungal pathogens and pests, fungicides and insecticides are used until the point in time of transplanting. The choice of the plant protection products, the place and timing of application and the application rate of the compositions are mainly a function of the type of fungal diseases and pests which are found, on the specific mode of action and duration of action of the compositions and on their plant tolerance and can thus be adapted directly to the specific requirement of different crops and regions.

### DESCRIPTION OF THE FIGURES

FIG. 1: Floating box filled with nutrient solution.

FIG. 2: Floating box with floating polystyrene seedling trays filled with seedling compost and tobacco seeds.

FIG. 3: Polystyrene seedling trays with tobacco plants after having been grown in a floating box.

### DESCRIPTION OF THE INVENTION

Among the insecticides which have been used in recent years, in particular for controlling sucking pests in the “floating method”, are also insecticides from the neonicotinoid class since these are known to be particularly effective against aphids which transmit viruses, against thrips, against leafhoppers and against whitefly species. In the “float method”, the plants are usually sprayed with CNI insecticides briefly before transplanting (Ntzanis, 2003), or “drenched” with CNI insecticides immediately before or during transplantation into the field (Leal, 2001; Rudolph and Rogers, 2001). Both application methods are technically relatively complicated.

As has been said, it is already known that insecticides from the neonicotinoid class of the formula (I)

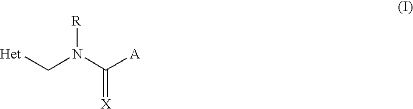

in which
Het represents a heterocycle which is in each case optionally mono- or polysubstituted by fluorine, chlorine, methyl or ethyl, selected from the following groups of heterocycles:
   pyrid-3-yl, pyrid-5-yl, 3-pyridinio, 1-oxido-5-pyridinio, 1-oxido-5-pyridinio, tetrahydro-furan-3-yl, thiazol-5-yl,
A represents C₁-C₆-alkyl, —N(R¹)(R²) or S(R²),
   in which
   R¹ represents hydrogen, C₁-C₆-alkyl, phenyl-C₁-C₄-alkyl, C₃-C₆-cycloalkyl, C₂-C₆-alkenyl or C₂-C₆-alkynyl, and
   R² represents C₁-C₆-alkyl, C₂-C₆-alkenyl, C₂-C₆-alkynyl, —C(═O)—CH₃ or benzyl,
R represents hydrogen, C₁-C₆-alkyl, C₂-C₆-alkenyl, C₂-C₆-alkynyl, —C(═O)—CH₃ or benzyl or together with R² represents one of the following groups:
   —CH₂—CH₂—, —CH₂—CH₂—CH₂—, —CH₂—O—CH₂—, —CH₂—S—CH₂—, —CH₂—NH—CH₂—, —CH₂—N(CH₃)—CH₂—, and
X represents N—NO₂, N—CN or CH—NO₂
   can be employed for controlling animal pests, in particular insects.
Het especially preferably represents a heterocycle selected from the following group of heterocycles:
   2-chloropyrid-5-yl, 2-methylpyrid-5-yl, 1-oxido-3-pyridinio, 2-chloro-1-oxido-5-pyridinio, 2,3-dichloro-1-oxido-5-pyridinio, tetrahydrofuran-3-yl, 5-methyl-tetrahydrofuran-3-yl, 2-chlorothiazol-5-yl.
A especially preferably represents —N(R¹)(R²).
R¹ especially preferably represents hydrogen, methyl or ethyl.
R² especially preferably represents methyl, methyl, n- or i-propyl, n-, i-, s- or t-butyl, ethenyl, 1-propenyl, 2-propenyl, ethynyl, 1-propynyl, 2-propynyl, —C(═O)—CH₃ or benzyl.
R especially preferably represents hydrogen, methyl, ethyl or —C(═O)—CH₃, or especially preferably together with R² represents one of the following groups:
   —CH₂—CH₂—, —CH₂—CH₂—CH₂—, —CH₂—O—CH₂—, —CH₂—S—CH₂—.

This class of compounds includes for example the following compounds, the enumeration not being construed as limiting:

imidacloprid, of the formula (I)

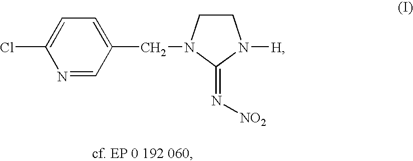

clothianidin, of the formula (II)

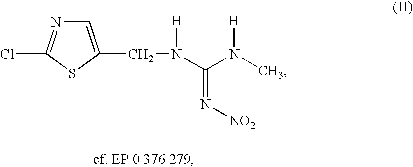

dinotefuran, of the formula (III)

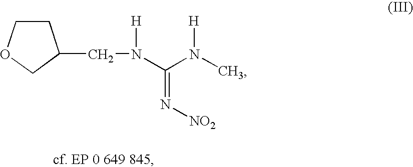

thiamethoxam, of the formula (IV)

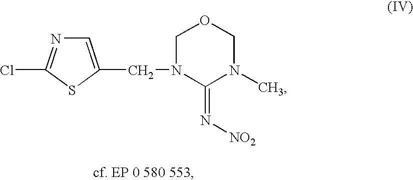

thiacloprid, of the formula (V)

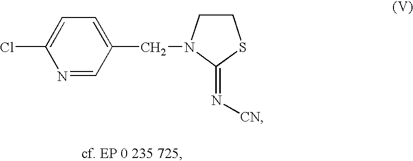

acetamiprid, of the formula (VI)

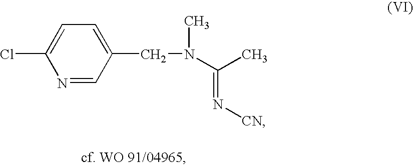

nitenpyram, of the formula (VII)

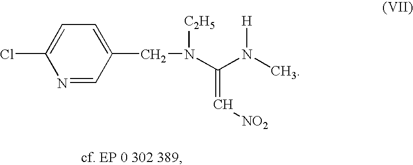

Surprisingly, experiments on the optimization of the use of CNIs, for example imidacloprid in the known formulation “Confidor SL 200” in the “float method” (see Examples 1 to 3) have shown that, in comparison with the untreated control and in comparison with the known drenching method, the direct admixture of the imidacloprid-containing formulation into the nutrient solution has induced promoted development of the young plants and, accordingly, a markedly increased shoot length during the seedling phase, including cases where no attack by pests took place. The head start in terms of development was retained even after transplantation into the field (Examples 1 and 2).

Thus, the nutrient solution should contain an effective amount of a compound selected from the group of the neonicotinoids, preferably a compound selected from the series consisting of imidacloprid, clothianidin, thiacloprid, thiamethoxam, acetamiprid, nitenpyram and dinotefuran, especially preferably imidacloprid, clothianidin and thiacloprid, and very especially preferably imidacloprid. Mixtures which should be mentioned in particular in this context are those comprising at least one neonicotinoid selected from the series consisting of imidacloprid, clothianidin, thiacloprid, thiamethoxam, acetamiprid, nitenpyram and dinotefuran and one further active ingredient, for example a further insecticide or a fungicide.

Insecticides which can preferably be employed in accordance with the invention in admixture with one or more of the abovementioned neonicotinoids, preferably either with imidacloprid or with clothianidin, are, for example, carbamates such as, for example, aldicarb, carbofuran, carbosulfan, thiodicarb, phosphoric esters such as, for example, dimethoate, phorate, terbufos, fiprols, such as, for example, fipronil, ethiprol, makrolides such as, for example, spinosad, amides such as, for example, flonicamid, soil-systemic BDCAs such as, for example AMSI 254, AMSI 334, DPX-E2Y45, ketoenols such as, for example BYI 8330, dihalopropenes such as, for example, pyridalyl.

Fungicides which can preferably be employed in accordance with the invention in admixture with one or more of the abovementioned neonicotinoids, preferably either with imidacloprid or with clothianidin, are, for example, acylalanines such as, for example, metalaxyl, mefenoxam, benalaxyl, imidazolinones, such as, for example, fenamidone, triazoles such as, for example, triadimenol, tebuconazole, fluquinconazole, prothioconazole, phosphonic acid derivatives such as, for example, fosethyl-Al, carbamates such as, for example, propamocarb, amino acid carbamidates such as, for example, iprovalicarb, methoxyacrylates such as, for example, azoxystrobin, picoxystrobin, trifloxystrobin, dihydrodioxazines such as, for example, fluoxastrobin, methoxycarbamates such as, for example, pyraclostrobin, oximinoacetamides such as, for example, metominostrobin, oxazolidinediones such as, for example, famoxadone, carboxamides such as, for example, AE C656948, benzamides such as, for example, AE C638206.

The neonicotinoid concentration in the nutrient solution can be varied within a substantial range. To achieve the inventive effect, concentrations from 0.0001% to 0.05% are preferred, from 0.0005% to 0.025% especially preferred and from 0.0025% to 0.005% very especially preferred. If mixtures according to the invention are employed, the concentration of the active ingredient combinations is preferably between 0.001% and 0.05%, especially preferably between 0.005% and 0.01%. Unless specified otherwise, the figures given hereinabove and hereinbelow are percent by weight.

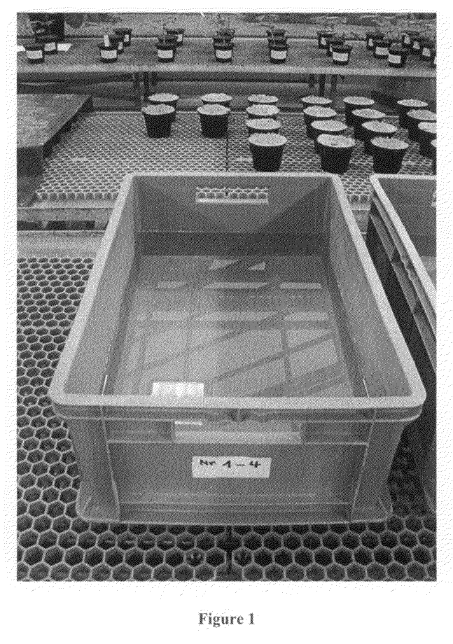

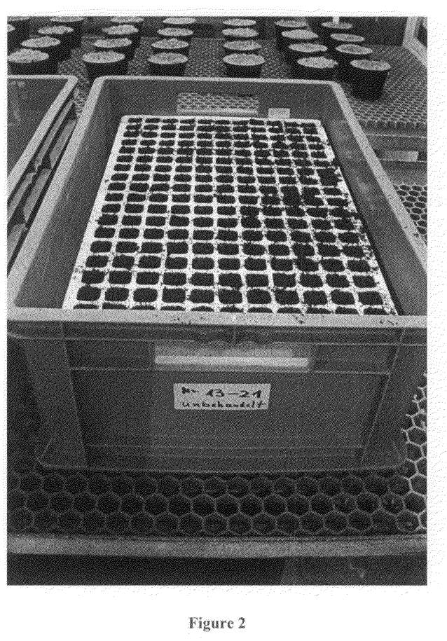

Equally, the present invention relates to methods for improving the plant development of plants, comprising raising plants in a nutrient solution which contains at least one compound selected from the group of the neonicotinoids. Preferably, the plants are raised in suitable containers using a medium which is suitable for the chosen plant species, with one or more of these containers containing media and plants or seed being transferred into another container which is filled with the nutrient solution according to the invention (FIGS. 1 and 2).

Moreover, it has been observed that the resistance to soil-borne phytopathogenic fungi has been improved significantly in comparison with untreated control, even after transplantation into the field (Example 3). Thus, the young plants treated in accordance with the invention significantly contribute to safeguarding the intended plant density in the field and form the basis for high yields, which was also discernible in the difference in plant height between treated and untreated plants towards the end of the vegetation period (Examples 1 and 2).

The present invention therefore relates to methods of increasing the resistance of plants to soil-borne phytopathogenic fungi, comprising raising plants in a nutrient solution which contains at least one compound selected from the group of the neonicotinoids. Preferably, the plants are raised in suitable containers using a medium which is suitable for the chosen plant species, with one or more of these containers containing media and plants or seed being transferred into another container which is filled with the nutrient solution according to the invention. The containers which contain the seed or the plants are allowed to float on the nutrient solution, which is why the method is referred to as “float method” or “floating method”.

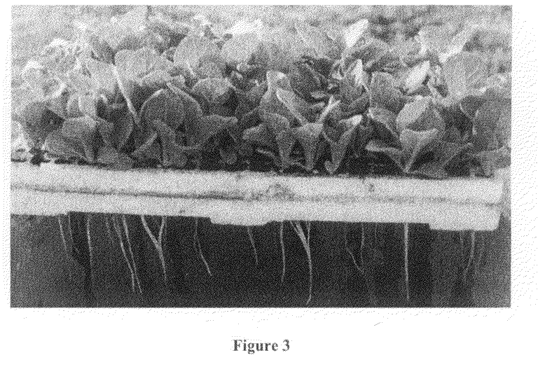

The containers or seedling trays which contain the seed or the plants are conventional containers or trays for raising plants. Normally, the containers consist of a material which is suitable for floating in the nutrient solution and which is not adversely affected by moisture, such as, for example, polystyrene (see FIG. 3). The containers or seedling trays used in the abovementioned “floating” method are known to the skilled worker.

The present invention also relates to nutrient solutions for raising plants, which nutrient solutions contain an effective amount of a compound selected from the group of the neonicotinoids, preferably a compound selected from the series consisting of imidacloprid, clothianidin, thiacloprid, thiamethoxam, acetamiprid, nitenpyram and dinotefuran, very especially imidacloprid, clothianidin and thiacloprid, and very especially preferably imidacloprid.

In the methods according to the invention, the seedling trays contain a medium which is suitable for raising specific plant species. In this context, it is possible to employ all of the customary media which are known to the skilled worker and which are conventionally used for raising young plants. Examples of such media are mentioned hereinabove.

A further advantage of the present invention is based on the fact that the direct application of the insecticide into the nutrient solution is less laborious and time consuming than the conventional drenching or spray application and therefore less costly and, last but not least, also more environmentally friendly as a result of a more targeted application of crop protection product. An adverse effect on the insecticidal activity after carrying out this method has not been observed.

While in comparison, a drenching application with the same application rate, but carried out immediately during transplanting or shortly thereafter, likewise showed clearly promoted plant development in comparison with the untreated control, the effects were significantly lower in comparison with the “float” method after direct admixture into the nutrient solution (Example 1).

Thus, the differences in promoted development and resistance to, for example, the soil-borne phytopathogenic fungus Phytophthora nicotianae were demonstrated after the application of imidacloprid (SL 200) by the “float” method after directly admixing the SL 200 formulation into the nutrient solution at an application rate of, for example, 25 ml/1000 seeds (0.5 l/ha), a preferred procedure being that half the application rate was applied at the beginning of raising the plants and half 10 days before transplantation.

Moreover, a novel imidacloprid SL 200 formulation which is based on propylene carbonate, which replaces the NMP (N-methylpyrrolidone) which was a constituent in previously used SL formulations, reveals particularly marked effects with regard to promoted development (Examples 1 and 2).

The active ingredient content of the nutrient solutions according to the invention, which are prepared from commercially available formulations, can vary within wide ranges. The active ingredient concentration of the use forms can range from 0.0001 to 0.05% by weight of active ingredient, preferably from 0.0005 and 0.025% by weight.

They are used in a customary manner adapted to the use forms.

The present invention therefore relates in particular to nutrient solutions as described above, which contain an NMP-free formulation of the active ingredient employed, and to their use in the methods according to the invention, described hereinabove and hereinbelow, for raising plants. In these preferred formulations or nutrient solutions, the NMP is replaced by propylene carbonate (see, in this context, also DE 102005008949). The propylene carbonate is preferably present in the formulation in a concentration of from 10-50% (by weight).

The nutrient solutions according to the invention and/or the methods according to the invention are well tolerated by plants, have a favourable toxicity to warm-blood species and are suitable for controlling animal pests, in particular insects, arachnids and nematodes which are found in agriculture. They can preferably be employed as plant protection products. The abovementioned pests include:

From the order of the Isopoda, for example Oniscus asellus, Armadillidium vulgare, Porcellio scaber. From the order of the Diplopoda, for example Blaniulus guttulatus. From the order of the Chilopoda, for example Geophilus carpophagus, Scutigera spp. From the order of the Symphyla, for example Scutigerella immaculata. From the order of the Thysanura, for example Lepisma saccharina. From the order of the Collembola, for example Onychiurus armatus. From the order of the Orthoptera, for example Acheta domesticus, Gryllotalpa spp., Locusta migratoria migratorioides, Melanoplus spp., Schistocerca gregaria. From the order of the Blattaria, for example Blatta orientalis, Periplaneta americana, Leucophaea maderae, Blattella germanica. From the order of the Dermaptera, for example Forficula auricularia. From the order of the Isoptera, for example Reticulitermes spp. From the order of the Phthiraptera, for example Pediculus humanus corporis, Haematopinus spp., Linognathus spp., Trichodectes spp., Damalinia spp. From the order of the Thysanoptera, for example Hercinothrips femoralis, Thrips tabaci, Thrips palmi, Frankliniella accidentalis. From the order of the Heteroptera, for example Eurygaster spp., Dysdercus intermedius, Piesma quadrata, Cimex lectularius, Rhodnius prolixus, Triatoma spp. From the order of the Homoptera, for example Aleurodes brassicae, Bemisia tabaci, Trialeurodes vaporariorum, Aphis gossypii, Brevicoryne brassicae, Cryptomyzus ribis, Aphis fabae, Aphis pomi, Eriosoma lanigerum, Hyalopterus arundinis, Phylloxera vastatrix, Pemphigus spp., Macrosiphum avenae, Myzus spp., Phorodon humuli, Rhopalosiphum padi, Empoasca spp., Euscelis bilobatus, Nephotettix cincticeps, Lecanium corni, Saissetia oleae, Laodelphax striatellus, Nilaparvata lugens, Aonidiella aurantii, Aspidiotus hederae, Pseudococcus spp., Psylla spp. From the order of the Lepidoptera, for example Pectinophora gossypiella, Bupalus piniarius, Chematobia brumata, Lithocolletis blancardella, Hyponomeuta padella, Plutella xylostella, Malacosoma neustria, Euproctis chrysorrhoea, Lymantria spp., Bucculatrix thurberiella, Phyllocnistis citrella, Agrotis spp., Euxoa spp., Feltia spp., Earias insulana, Heliothis spp., Mamestra brassicae, Panolis flammea, Spodoptera spp., Trichoplusia ni, Carpocapsa pomonella, Pieris spp., Chilo spp., Pyrausta nubilalis, Ephestia kuehniella, Galleria mellonella, Tineola bisselliella, Tinea pellionella, Hofmannophila pseudospretella, Cacoecia podana, Capua reticulana, Choristoneura fumiferana, Clysia ambiguella, Homona magnanima, Tortrix viridana, Cnaphalocerus spp., Oulema oryzae. From the order of the Coleoptera, for example Anobium punctatum, Rhizopertha dominica, Bruchidius obtectus, Acanthoscelides obtectus, Hylotrupes bajulus, Agelastica alni, Leptinotarsa decemlineata, Phaedon cochleariae, Diabrotica spp., Psylliodes chrysocephala, Epilachna varivestis, Atomaria spp., Oryzaephilus surinamensis, Anthonomus spp., Sitophilus spp., Otiorrhynchus sulcatus, Cosmopolites sordidus, Ceuthorrhynchus assimilis, Hypera postica, Dermestes spp., Trogoderma spp., Anthrenus spp., Attagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha melolontha, Amphimallon solstitialis, Costelytra zealandica, Lissorhoptrus oryzophilus. From the order of the Hymenoptera, for example z.B. Diprion spp., Hoplocampa spp., Lasius spp., Monomorium pharaonis, Vespa spp. From the order of the Diptera, for example Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae, Tipula paludosa, Hylemyia spp., Liriomyza spp. From the order of the Siphonaptera, for example Xenopsylla cheopis, Ceratophyllus spp. From the class of the Arachnida, for example Scorpio maurus, Latrodectus mactans, Acarus siro, Argas spp., Ornithodoros spp., Dermanyssus gallinae, Eriophyes ribis, Phyllocoptruta oleivora, Boophilus spp., Rhipicephalus spp., Amblyomma spp., Hyalomma spp., Ixodes spp., Psoroptes spp., Chorioptes spp., Sarcoptes spp., Tarsonemus spp., Bryobia praetiosa, Panonychus spp., Tetranychus spp., Hemitarsonemus spp., Brevipalpus spp. The phytoparasitic nematodes include for example Pratylenchus spp., Radopholus similis, Ditylenchus dipsaci, Tylenchulus semipenetrans, Heterodera spp., Globodera spp., Meloidogyne spp., Aphelenchoides spp., Longidorus spp., Xiphinema spp., Trichodorus spp., Bursaphelenchus spp.

Likewise, the method and/or nutrient solutions according to the invention are suitable for controlling undesired fungi and also microorganisms. The methods can be employed particularly advantageously for controlling soil-borne harmful fungi. Relevant harmful fungi or microorganisms comprise, for example, Plasmodiophoromycetes, Oomycetes, Chytridiomycetes, Zygomycetes, Ascomycetes, Basidiomycetes and Deuteromycetes. Examples of some pathogens causing fungal and bacterial diseases which come under the above generic terms and which may be mentioned, but not by limitation, are: Xanthomonas species such as, for example, Xanthomonas campestris pv. oryzae; Pseudomonas species such as, for example, Pseudomonas syringae pv. lachrymans; Erwinia species such as, for example, Erwinia amylovora; Pythium species such as, for example, Pythium ultimum; Phytophthora species such as, for example, Phytophthora infestans; Pseudoperonospora species such as, for example, Pseudoperonospora humuli or Pseudoperonospora cubensis; Plasmopara species such as, for example, Plasmopara viticola; Bremia species such as, for example, Bremia lactucae; Peronospora species such as, for example, Peronospora pisi or P. brassicae; Erysiphe species such as, for example, Erysiphe graminis; Sphaerotheca species such as, for example, Sphaerotheca fuliginea; Podosphaera species such as, for example, Podosphaera leucotricha; Venturia species such as, for example, Venturia inaequalis; Pyrenophora species such as, for example, Pyrenophora teres or P. graminea (conidial form: Drechslera, syn: Helminthosporium); Cochliobolus species such as, for example, Cochliobolus sativus (conidial form: Drechslera, syn: Helminthosporium); Uromyces species such as, for example, Uromyces appendiculatus; Puccinia species such as, for example, Puccinia recondita; Sclerotinia species such as, for example, Sclerotinia sclerotiorum; Tilletia species such as, for example, Tilletia caries; Ustilago species such as, for example, Ustilago nuda or Ustilago avenae; Pellicularia species such as, for example, Pellicularia sasakii; Pyricularia species such as, for example, Pyricularia oryzae; Fusarium species such as, for example, Fusarium culmorum; Botrytis species such as, for example, Botrytis cinerea; Septoria species such as, for example, Septoria nodorum; Leptosphaeria species such as, for example, Leptosphaeria nodorum; Cercospora species such as, for example, Cercospora canescens; Alternaria species such as, for example, Alternaria brassicae; Pseudocercosporella species such as, for example, Pseudocercosporella herpotrichoides.

As mentioned above, the active ingredients according to the invention in particular also have a potent strengthening effect in plants. They are therefore suitable for mobilizing the plants' intrinsic defenses against attack by undesired microorganisms.

In the present context, the term “strengthening effect” of substances refers to the ability of substances to stimulate the defense system of plants in such a way that the treated plants display a substantial resistance when subsequently being inoculated with undesired microorganisms and/or fungi.

In the present case, undesired microorganisms are understood as meaning phytopathogenic fungi, bacteria and viruses. Thus, the substances according to the invention can also be employed for protecting plants within a certain period of time after the treatment against attack by the abovementioned pathogens. The period of time within which protection is afforded comprises the phase during which the young plants are raised in the “float” system and generally extends to the period after transplanting into the open. During this phase, the young plants are particularly susceptible to soil-borne fungal infection as their roots will have suffered mechanical damage owing to the transplantation process.

The good tolerance, by plants, of the active ingredients at the concentrations required for controlling plant diseases permits a treatment according to the invention of the plant material and the seed, and of the soil or medium in which the seed or the plants are present.

The methods and/or nutrient solutions according to the invention can be employed particularly successfully for controlling soil-borne phytopathogenic fungi, especially of the genus Phytophthora spec, Pythium spec, Rhizoctonia spec., Fusarium spec., Aphanomyces spec., Olpidium spec., Plasmodiophora spec. and Verticillium spec.

The “float” method according to the invention for raising young plants, which involves the direct admixture of a neonicotinoid, preferably imidacloprid, to nutrient solutions for promoting the development and increasing the resistance to soil-borne phytopathogenic fungi is suitable for raising young plants of a series of agricultural, horticultural and silvicultural crops.

Particular mention may be made of the suitability of the method according to the invention in raising young plants of the following crops: tobacco, sugar beet, in particular also vegetables comprising leaf vegetables such as, for example, endives, lamb's lettuce, Florence fennel, head lettuce and loose-leaf lettuce, Swiss chard, spinach and chicory, cabbages such as, for example, cauliflower, broccoli, Chinese leaves, curly kale (feathered cabbage), kohl rabi, Brussels sprouts, red cabbage, white cabbage and Savoy cabbage, fruit vegetables such as, for example, aubergines, cucumbers, bell peppers, marrows, pumpkins and squash, tomatoes and courgettes, root vegetables such as celeriac and bulb vegetables such as, for example, leeks and onions.

It is especially preferred in accordance with the invention to treat plants of the plant varieties which are in each case commercially available or in use. Plant varieties are understood as meaning plants with new traits which have been bred by all of the following: conventional breeding, mutagenesis or with the aid of recombinant DNA technologies. Accordingly, crops can be plants which can be obtained by means of conventional breeding and optimization methods or by bio-technological and genetic engineering methods or by combinations of these methods, including the transgenic plants and including the plant varieties which can be protected or not by Plant Breeders' Rights.

It is desirable to optimize the amount of the active ingredient, or active ingredient combination, employed in the sense that the seed and the germinating plant is protected as much as possible against attack by pests or harmful fungi without at the same time harming the seed or its germination, or the emerging plant itself, by the active ingredient employed. The methods according to the invention should therefore also include the intrinsic insecticidal properties of transgenic plants in order to achieve optimal protection of the seed and the germinating plant while employing a minimum of plant protectants.

The examples which follow illustrate the particular advantages of the method according to the invention and the nutrient solutions according to the invention. The examples are not to be construed as limiting.

### EXAMPLES

### Example 1

### Direct Admixture of Imidacloprid into the “Floating” System when Raising Young Tobacco Plants

To prepare a suitable use solution, 1 part by weight of commercially available formulated product (Confidor SL 200) was diluted with water to obtain the desired concentration of 0.005% active ingredient. 10 days prior to transplanting, a second application of Confidor SL 200 into the nutrient solution was carried out, corresponding to 0.005% active ingredient.

Seed of tobacco plants was sown in a specific, peat-medium-based seedling compost in perforated polystyrene trays and subsequently grown on in containers filled with nutrient solution based on 0.1% Bayfolan® until the plants had reached the desired size for transplanting. In this context, the Confidor SL 200 formulation was added directly to the nutrient solution of the “floating” system.

In comparison, raising the young plants according to the prior art under otherwise identical conditions involved drenching the young plants with the formulation according to the invention after they had been transplanted.

This test demonstrated for example the following superiority in comparison with the prior art (Table A):

TABLE A
Plant development/tobacco

| | Shoot length in % of |
|---|---|
| | the untreated control |
| Raising system | (7 days after transplanting) |
| “Floating” system with direct addition | 180 |
| of Confidor SL 200 into the nutrient solution | |
| (according to the invention) | |
| “Floating” system with subsequent | 105 |
| drenching with Confidor SL 200 at | |
| the transplantation stage (prior art) | |

### Example 2

### Comparison of a Propylene-Carbonate-Containing Formulation (According to the Invention) With an NMP-Containing Imidacloprid Formulation in the “Floating” System for Raising Young Tobacco Plants

To prepare a suitable use solution, 1 part by weight of commercially available formulated product (Confidor SL 200) was diluted with water to obtain the desired concentration of 0.005% active ingredient. 10 days prior to transplanting, a second application of Confidor SL 200 into the nutrient solution was carried out, corresponding to 0.005% active ingredient.

Seed of tobacco plants was sown in a specific, peat-medium-based seedling compost in perforated polystyrene trays and subsequently grown on in containers filled with appropriate nutrient solution until the plants had reached the desired size for transplanting. In this context, the formulations were added directly to the nutrient solution of the “floating” system.

This test demonstrated for example the following superiority in comparison with the prior art (Table B):

TABLE B
Plant development/tobacco

| | Shoot length in % of |
|---|---|
| | the untreated control |
| Formulation | (7 days after transplanting) |
| Confidor SL 200 | 180 |
| (propylene-carbonate-containing) | |
| (according to the invention) | |
| Confidor SL 200 (NMP-containing) | 133 |
| (prior art) | |

### Example 3

### Effect of a New Propylene-Carbonate-Containing Imidacloprid Formulation Against Phytophthora nicotianae After Direct Admixture into the Nutrient Solution of the “Floating” System when Raising Young Tobacco Plants (Field Experiment)

To prepare a suitable use solution, 1 part by weight of commercially available formulated product (Confidor SL 200) was diluted with water to obtain the desired concentration of 0.005% active ingredient. 10 days prior to transplanting, a second application of Confidor SL 200 was carried out, corresponding to 0.005% active ingredient.

Seed of tobacco plants was sown in a specific, peat-medium-based seedling compost in perforated polystyrene trays and subsequently grown on in containers filled with appropriate nutrient solution until the plants had reached the desired size for transplanting. In this context, the formulation was added directly to the nutrient solution of the “floating” system.

After the young plants had reached the transplantation size, they were transplanted into the field. Locations with a natural potential for infection with Phytophthora nicotianae result in infection of the roots and the crown via the soil.

This test demonstrated for example the following effectiveness of the formulation according to the invention (Table C):

TABLE C
Phytopathogenic fungi/Phytophthora nicotianae/tobacco

| | % efficacy as |
|---|---|
| Formulation | defined by Abbott |
| Confidor SL 200 (propylene-carbonate-containing) | 91 |
| (according to the invention) | |
| Untreated control | 0 |

### REFERENCES

1. Leal, R. S. (2001): The use of Confidor S in the float, a new tobacco seedlings production system in the south of Brazil. Pflanzenschutz-Nachrichten Bayer, 54/3, p. 337-352.
2. Ntzanis, I. (2003): Anzuchtverfahren für Virginia Tabak—Float System [Raising method for Virginia tobacco—“float” system]. Georgia, 2, p. 16-39. (In Greek).
3. Rudolph, R. D. and Rogers, W. D. (2001): The efficacy of imidacloprid treatment for reduction in the severity of insect vectored virus diseases of tobacco. Pflanzenschutz-Nachrichten Bayer, 54/3, p. 311-336.

1. A method for improving plant development, or increasing the resistance of a plant, or both, comprising adding at least one compound selected from the neonicotinoid class of the formula (I) 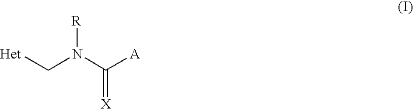
wherein
Het is selected from the group of heterocycles consisting of:
2-chloropyrid-5-yl, 2-methylpyrid-5-yl, 1-oxido-3-pyridinio, 2-chloro-1-oxido-5-pyridinio, 2,3-dichloro-1-oxido-5-pyridinio, tetrahydrofuran-3-yl, 5-methyl-tetrahydrofuran-3-yl, and 2-chlorothiazol-5-yl;
A is —N(R¹)(R²),
R¹ is hydrogen, methyl or ethyl,
R² is methyl, ethyl, n-propyl, i-propyl, n-butyl, i-butyl, s-butyl t-butyl, ethenyl, 1-propenyl, 2-propenyl, ethynyl, 1-propynyl, —C(═O)—CH₃ or benzyl,
R is hydrogen, methyl, ethyl or —C(═O)—CH₃ or together with R² is one of the following
—CH₂—CH₂—, —CH₂—CH₂—CH₂—, —CH₂—O—CH₂—, or —CH₂—S—CH₂—, and
X is N—NO₂. N—CN or CH—NO₂,
to a nutrient solution which is suitable for raising a plant, wherein one or more additional plant protectants are optionally added to the nutrient solution.

2. The method according to claim 1, wherein the neonicotinoid is selected from the group consisting of imidacloprid, clothianidin, thiacloprid, dinotefuran, thiamethoxam, acetamiprid and nitenpyram.

3. The method according to claim 2, wherein between 0.0005% and 0.025% by weight of imidacloprid is added to the nutrient solution.

4. The method according to claim 1, wherein at least one of the neonicotinoids is added to a nutrient solution for raising a plant as from seed.

5. The method according to claim 1, wherein the plant is grown by the float method.

6. A nutrient solution for raising a plant, comprising at least one compound from the class of the neonicotinoids according to claim 1 in an effective amount for improving plant development, increasing the resistance of plants, or both.

7. The nutrient solution according to claim 6, wherein the neonicotinoid comprises of between 0.0005% and 0.025% by weight of imidacloprid.

8. The nutrient solution according to claim 6, wherein the neonicotinoid is added to the nutrient solution in the form of an NMP-free formulation comprising 10-50% by weight of propylene carbonate.

9. A method for improving plant development, increasing the resistance of a plant to soil-borne plant pathogens, or both, comprising adding the nutrient solution according to claim 6 to at least one of a plant material, a seed, a soil or a medium in which a seed or a plant is present.

10. The method according to claim 9 wherein the nutrient solution is contacted to a seed.

11. The method according to claim 9, wherein the nutrient solution is added to a medium in which a seed or plant is present.

12. The method according to claim 9, wherein the medium in which a seed or plant is present is a float system.

13. The method according to claim 9, wherein the soil-borne plant pathogen comprises a phytopathogenic fungus, a bacterium or a virus.

14. The method according to claim 9, wherein the soil-borne plant pathogen is a phytopathogenic fungus.

15. The method according to claim 14, wherein the phytopathogenic fungus comprises a species selected from the genera Phytophthora, Pythium, Rhizoctonia, Fusarium, Aphanomyces, Olpidium, Plasmodiophora and Verticillium.

16. The method according to claim 12, wherein addition to the float system is direct.
